(19) United States
(12) Patent Application Publication
(10) Pub. No.: US 2011/0276181 A1
(43) Pub. Date: Nov. 10, 2011

(54) PROGRAMMABLE ELECTRIC HAND TRUCK

(76) Inventors: Aaron Lamb, West Fargo, ND (US); Douglas Snider, Chicago, IL (US)

(21) Appl. No.: 13/051,779

(22) Filed: Mar. 18, 2011

Related U.S. Application Data
(60) Provisional application No. 61/332,769, filed on May 8, 2010.

(51) Int. Cl. B62B 1/00; G05B 15/02

(52) U.S. Cl. 700/275; 414/800

(57) ABSTRACT

Hand trucks and methods for displacing an object with a hand truck are disclosed. An example hand truck includes a lifting toe and a lift apparatus coupled to the lifting toe and configured to displace the lifting toe. A microprocessor is configured to output a plurality of control signals. An actuator is coupled to the lift apparatus and is configured to displace the lift apparatus responsive at least in part to the microprocessor outputting at least one of a plurality of control signals. An example method includes changing the load on a lifting toe from a first weight to a second weight and activating an actuator responsive at least in part on changing the load. A lift sled is moved in a first direction responsive to the activation of the actuator and the lifting toe is moved in the first direction by the lift sled.

### CROSS REFERENCE TO RELATED APPLICATION(S)

This application claims priority to Provisional Application No. 61/332,769, filed May 8, 2010, which application is incorporated herein by reference, in its entirety, for any purpose.

### TECHNICAL FIELD

Embodiments of the present invention relate generally to hand trucks, and more specifically, in one or more of the illustrated embodiments, to programmable electric hand trucks.

### BACKGROUND OF THE INVENTION

The use of hand trucks is well known. Hand trucks have long been used to assist in transporting objects, such as perishables, appliances, furniture, tools, and containers. However, many hand trucks require repetitive combinations of bending and lifting to add and remove items from the hand truck toe. This process can be both taxing and time consuming for a user, particularly for those in involved with product delivery and product distribution. Additionally, many hand trucks are not equipped to help with deliveries requiring multiple specific toes. One delivery for example, may require a forked toe for pallets, a flat toe for boxes, and a hoist toe for lifting heavy items. Thus, in many cases, a single delivery may require several different hand trucks to provide different toes.

Therefore, a need exists for a hand truck that can adjust the height of a toe to reduce the amount of strain on a user loading and unloading objects. There may be an additional need for a hand truck providing a modular toe system to allow for transport of a variety of objects in a single delivery.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures.

FIG. 1 is a front perspective view of a hand truck according to an embodiment of the invention.

FIG. 2 is a front perspective view of a hand truck according to an embodiment of the invention.

FIG. 3 is a front perspective view of a hand truck according to an embodiment of the invention.

FIG. 4 is a block diagram of a control box according to an embodiment of the invention.

FIG. 5 is a rear perspective view of a hand truck according to an embodiment of the invention.

FIG. 6 is a perspective cut-away view of hand truck 100 according to an embodiment of the invention.

FIG. 7 is a perspective view of a lift sled according to an embodiment of the invention.

FIG. 8 is a front perspective view of a hand truck according to an embodiment of the invention.

FIG. 9 is a front perspective view of a lifting toe according to an embodiment of the invention.

FIG. 10 is a front perspective cut-away view of a hand truck according to an embodiment of the invention.

FIG. 11 is a front perspective view of a hand truck according to an embodiment of the invention.

FIG. 12 is a front perspective cut-away view of a hand truck according to an embodiment of the invention.

FIG. 13 is a front perspective view of a hand truck according to an embodiment of the invention.

### DETAILED DESCRIPTION

Embodiments of the invention are directed toward a programmable electric hand truck. Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments.

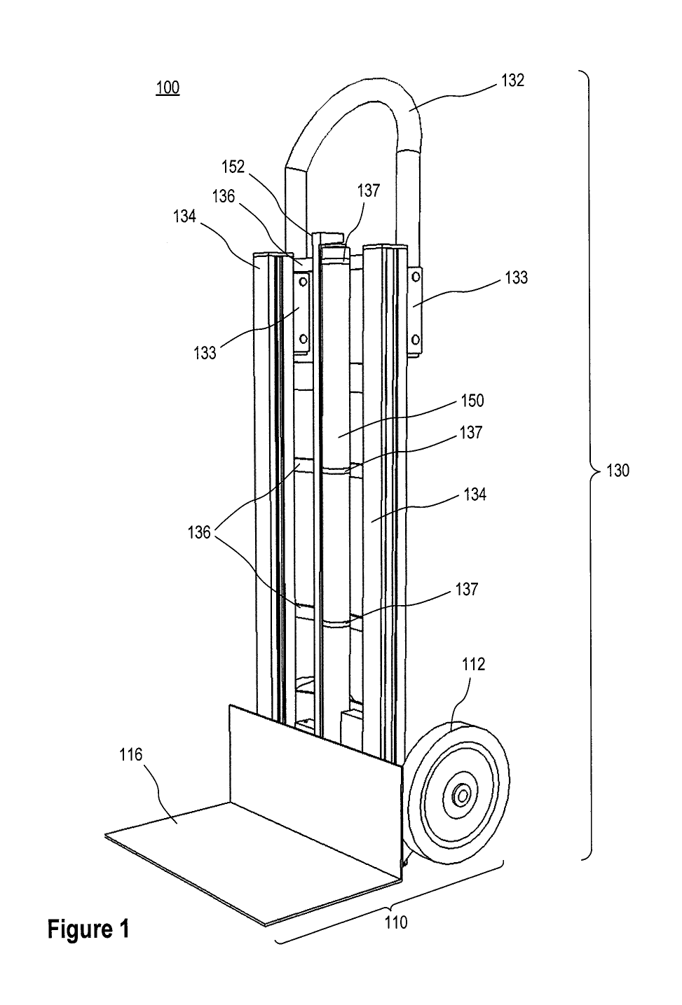

FIG. 1 illustrates a hand truck 100 according to an embodiment of the invention. Hand truck 100 may comprise a base 110 and a tower 130. Tower 130 may include a handle 132, side members 134, and an actuator 150. The handle 132 may be coupled to side members 134 by brackets 133. Brackets 133 may be fixed to side members 134 using any method of coupling known by those skilled in the art. For example, brackets 133 may be attached to side members 134 using screws, bolts, welding, or adhesives.

In some embodiments, brackets 133 may be configured to receive handle 134 such that handle 134 may be removable and/or interchangeable with other handles. Moreover, handle 134 may be U-shaped, T-shaped, H-shaped, or separate, dual handle bars. In other embodiments, brackets 133 may be permanently fixed to handle 132 or handle 134 may be directly coupled to side members 134.

Side members 134 may extend at least from base 110 to brackets 133 in a substantially linear manner and define a width of tower 130. Support braces 136 may be coupled to side members 134, spanning across the width of tower 130. In one embodiment, support braces 136 may be in spaced-apart parallel relation to one another and substantially perpendicular to side members 134. Additionally, in some embodiments, support braces 136 may be attached to side members 134 using any method of coupling known by those having skill in the art. For example, screws, bolts, welding, or adhesive may be used.

Tower 130 may further include an actuator 150. As will described in more detail below, the actuator 150 may be used to provide lifting force to a lifting toe 116. In some embodiments, the actuator 150 may be a mechanical linear actuator and coupled to support braces 136 by support rings 137. Alternatively, actuator 150 may be directly attached to support braces 136 using any method of coupling known by those having skill in the art, such as screws, bolts, clamps, welding, or adhesives. Actuator 150 may substantially span the length of tower 130 and further include a lift bar 152.

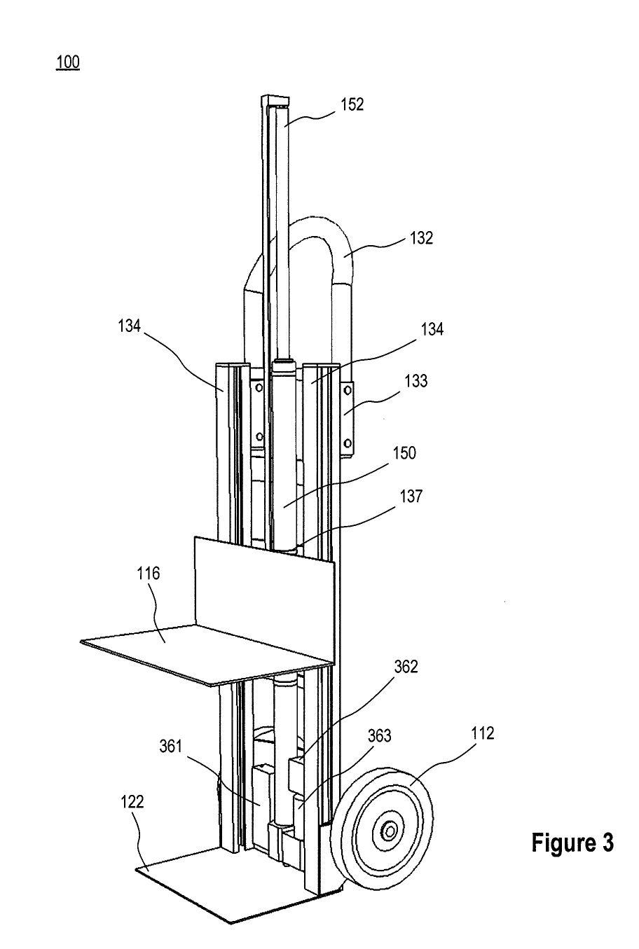

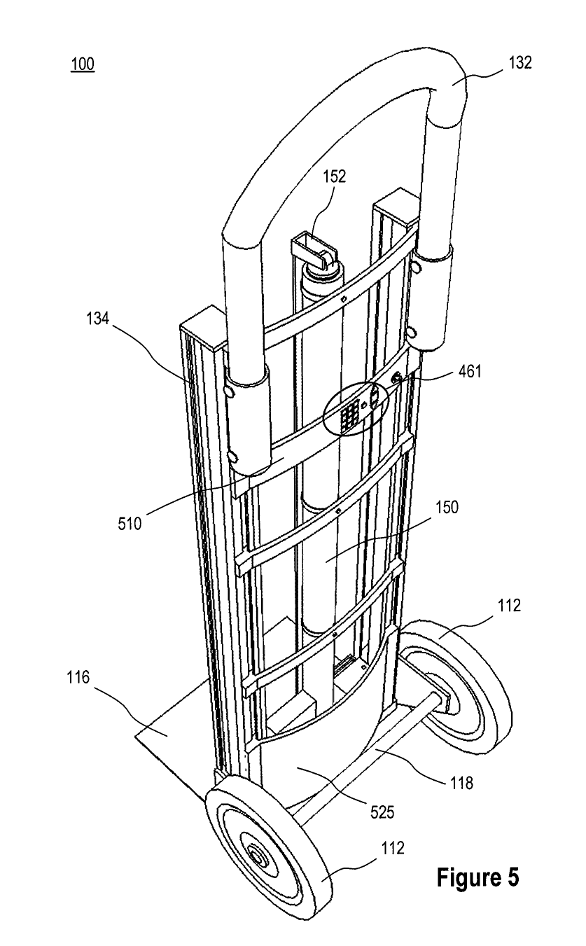

With reference to FIGS. 3 and 5, base 110 may include wheels 112, axle 118, and a base plate 122. Base plate 122 may be coupled to a longitudinal end of each side member 134 and protrude outward from tower 130. In at least one embodiment, base plate 122 is substantially planar. In other embodiments, base plate 122 may be curved or multi-planar.

Tower 130 and base plate 122 may further be coupled to the wheels 112. Additionally, in at least one embodiment, wheels 112 may be coupled together by the axle 118 in such fashion that wheels 112 rotate together. In another embodiment, wheels 112 may include brakes (not shown) and/or wheel locks (not shown) that may be configured to partially or fully prevent wheels 112 from rotating. Wheels 112 may comprise rubber, but those having skill in the art will recognize that wheels 112 may comprise any rigid material, including steel, sheet metal, plastic, wood, combinations thereof, or other suitable materials for adequate rolling, wear, and friction properties.

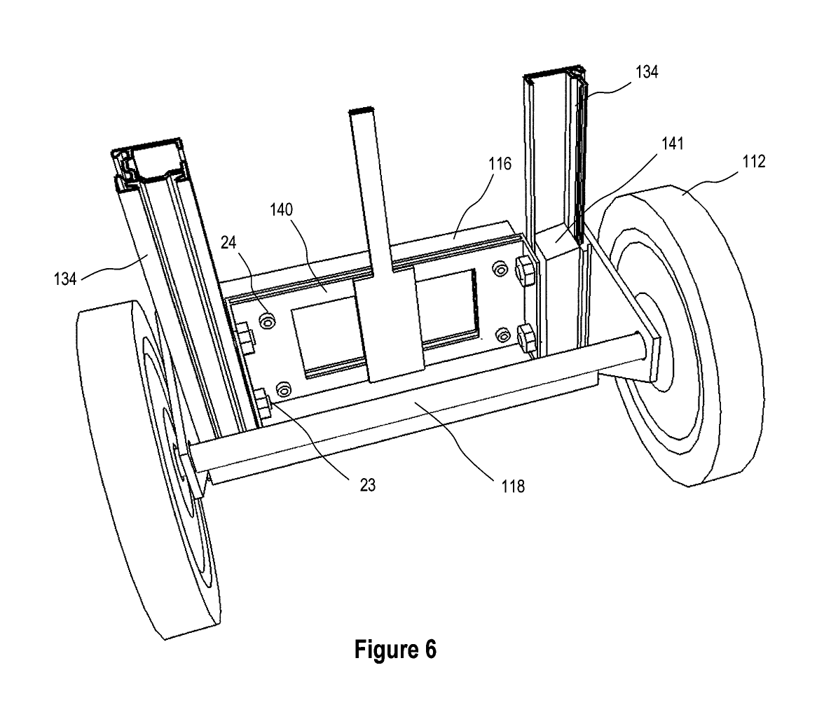

With reference to FIGS. 3 and 6, a lifting toe 116 may be coupled to a lift sled 140. As will be explained in more detail below, the position of lifting toe 116 may be adjusted by moving the attached lift sled 140 up or down relative to base 110. In at least one embodiment, the actuator 150 may be activated to cause lift bar 152 to raise or lower and in turn displace the lift sled 140 coupled to the lift bar 152. Thus, any object positioned on or suspended from lifting toe 116 may be displaced in substantially the same direction and distance as the lift bar 152 when moved by actuator 150.

Elements of hand truck 100, for example, those shown in FIG. 1, may comprise a metallic material such as extruded aluminum, extruded magnesium, bonded aluminum, or steel, but those having skill in the art will recognize that these elements may comprise any rigid material, including plastic, wood, carbon fiber, or combinations thereof, and further may be of any thickness.

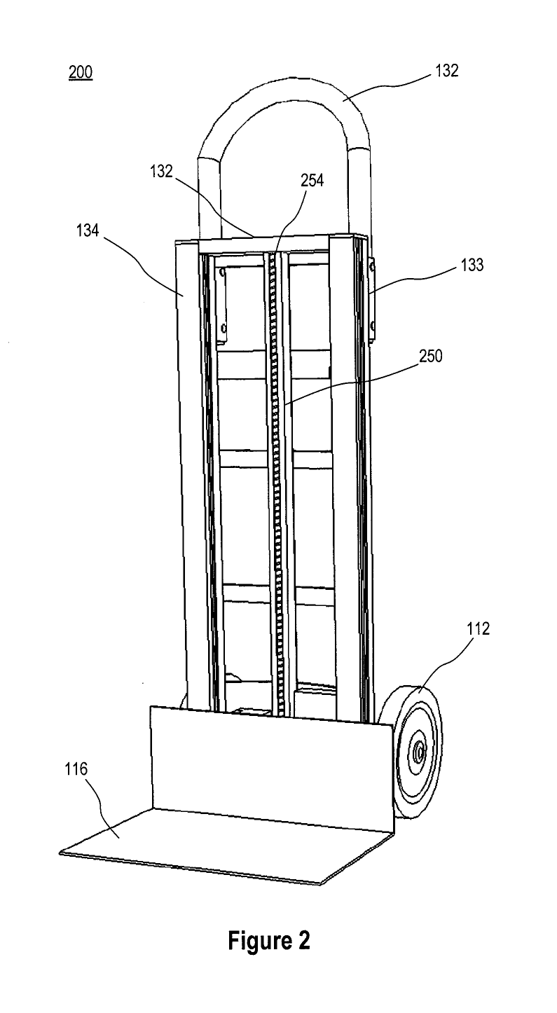

In one embodiment, hand truck 100 may include an actuator 250 as illustrated in FIG. 2. Unlike the embodiment illustrated in FIG. 1, the lift sled 140 is not coupled to the actuator 250 using a lift bar. The lift sled 140 may be coupled, for example, to a threaded lift bracket (not shown) instead of a lift bar 152. The lift bracket may be coupled to a screw shaft 254 of the actuator 250 such that rotation of the screw shaft 254 causes the lift bracket and an attached lift sled 140 to be raised or lowered.

In operation, when actuator 250 is activated, screw shaft 254 may begin to rotate around its longitudinal axis and move threaded lift bracket up or down based on the direction of rotation. Because lift sled 140 is coupled to threaded lift bracket, as threaded lift bracket moves up or down, lift sled 140 may also be displaced. Thus, the height of lifting toe 116 attached to lift sled 140 may be controlled with actuator 250. In some embodiments, actuator 250 may be a ball screw actuator, a roller screw actuator, or other actuators known by those having skill in the art.

In other embodiments, hand truck 100 may not include an actuator and displace lift sled 140 with other devices. For example, in other embodiments, hand truck 100 may include a cable and pulley apparatus (not shown) or a hand crank for manual displacement of lift sled 140. Those having skill in the art will appreciate that various implementations are possible, and that the present invention is not limited to these particular embodiments.

Hand truck 100 may further include a battery 361, control box 362, and motor 363 as illustrated in FIG. 3. Battery 361, control box 362, and motor 363 may be located between side members 134, but also may be located elsewhere on hand truck 100.

In some embodiments, battery 361 may be swappable and/or rechargeable. For example, battery 361 may be a nickel cadmium battery, but those having skill in the art will recognize that battery 361 may comprise any type of rechargeable battery, including nickel metal hydride, lithium ion, and lithium ion polymer. Additionally, battery 361 may be recharged from any standard power source, such as a car battery or wall outlet.

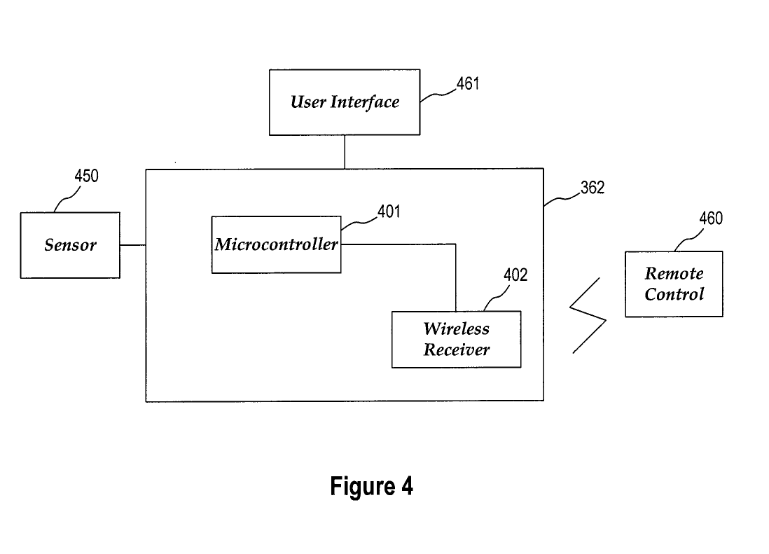

In operation, motor 363 may derive power from battery 361 and activate actuator 150 based on control signals received from a microprocessor 401 (FIG. 4) in control box 362. As described above, because lifting toe 116 is coupled to lift sled 140 to which the lift bar 152 is attached, when actuator 150 is activated and lift bar 152 is displaced, lifting toe 116 may also be displaced. In at least one embodiment, control signals received by motor 363 may indicate the direction lifting toe 116 is to be displaced. For example, a control signal may cause motor 363 to raise lifting toe 116 by raising lift bar 152 with actuator 150. In other embodiments, control signals 363 may control the rate, distance, and/or power with which lifting toe 116 is to be displaced.

FIG. 4 illustrates a block diagram of a control box 362 according to an embodiment of the present invention. Control box 362 may include a programmable microprocessor 401 comprising random access memory, read only memory, a central processing unit and/or control logic. A wireless interface 402 may be coupled to microprocessor 401 and configured to interface with a remote control 460 and/or a user control interface 461. In one embodiment, wireless interface 402 is a receiver capable of receiving data. In another embodiment, wireless interface 402 is a transceiver capable of both receiving and transmitting data. Wireless interface 402 may be configured to transmit with any wireless communication protocol known by those having ordinary skill in the art. For example, wireless interface 402 may be configured to communicate over Bluetooth, RF, or wireless Ethernet protocols.

Microprocessor 401 may further be coupled to a sensor 450 that may communicate with microprocessor 401 to provide data corresponding to objects supported by lifting toe 116. For example, sensor 450 may be a weight sensor and measure the weight of objects placed on lifting toe 116.

In at least one embodiment, microprocessor 401 may have a program mode, a user mode, and an upgrade mode. In program mode, programmed sequences may be executed in microprocessor 401 to dictate how the height of lifting toe 116 may be adjusted relative to base 110 in response to changes in parameters. In at least one embodiment, microprocessor 401 may be configured to increase or decrease the height of lifting toe 116 a predetermined distance each time sensor 450 senses an item has been added to or removed from lifting toe 116. In another embodiment, microprocessor 401 may be configured to displace lifting toe 116 a distance proportionate to an amount of weight added to or removed from lifting toe 116. In yet another embodiment, microprocessor 401 may be programmed to adjust the height of lifting toe 116 based on a time and/or time intervals.

For example, if a product A weighing 6 lbs. and having a height of 8 inches, is placed on lifting toe 116, sensor 450 may detect the additional 6 lbs. added to lifting toe 116 and couple data corresponding to the parameter change to microprocessor 401. Microprocessor 401 may be programmed to associate 6 lbs. of added load to a product having a height of 8 inches, and upon receiving the signal from sensor 450, lower lifting toe 116 8 inches. This may allow the next object to be added to lifting toe 116 at the same height as product A. Additionally, other weights may be mapped to other heights in microprocessor 401 to allow for a variety of objects to be stacked on lifting toe 116 and for the height of lifting toe 116 to be adjusted accordingly.

Microprocessor 401 may further be configured to execute sequences in reverse as well. For example, upon removal of product A from lifting toe 116, the reduced weight on lifting toe 116 may be sensed and the height of lifting toe 116 raised by the appropriate amount. Those having skill in the art will appreciate that various implementations are possible, and that the present invention is not limited to these particular embodiments.

In a user mode, microprocessor 401 may receive and execute manual commands. For example, microprocessor 401 may receive commands from remote control 460 or user interface 461 indicating a direction and distance in which to displace lifting toe 116. Additionally, user commands may specify the rate, length of time, and/or force with which the lifting toe 116 is to be displaced. In at least one embodiment, user commands may enable or disable the microprocessor 401 and/or the motor 363. In another embodiment, user commands may specify the mode in which microprocessor 401 may operate.

Microprocessor 401 may also utilize an upgrade mode for operation. Upgrade mode may allow microprocessor 401 to receive and implement new configurations for program mode, user mode, or control of coupled devices.

FIG. 5 illustrates a rear perspective view of hand truck 100. With reference to FIG. 4, user interface 461 may be included on a control bracket 510. Thus, user interface 461 on control bracket 510 may be used to update configurations in microprocessor 401 and/or control operation of hand truck 100 as discussed above. In one embodiment, control wires coupling control signals from user interface 461 to control box 362 may be routed through a conduit (not shown) or inside a side member 134. In another embodiment, control signals may be transmitted wirelessly.

Hand truck 100 may further include a shield plate 525 that spans across the width of hand truck 100. Shield plate 525 may be placed between base 110 and axle 118 and partially enclose base 110. Shield plate 525 may comprise a metallic material such as extruded aluminum, extruded magnesium, bond aluminum, or steel, but those having skill in the art will recognize that shield plate 525 may comprise any rigid material, including plastic, wood, carbon fiber, or combinations thereof. In at least one embodiment, shield plate 525 may have an arc shape. In other embodiments, shield plate may be planar or multi-planar.

FIG. 6 illustrates a perspective cut-away view of hand truck 100 according to an embodiment of the invention wherein some of the elements of hand truck 100 have been omitted for clarity. Hand truck 100 may include a lift sled 140 coupled to guide blocks 141. Lift sled 140 may coupled to guide blocks 141, for example, with bolts and nuts. Guide blocks 141 may comprise a rigid material, such as metal, but those having skill in the art will appreciate that any suitable rigid material may be used.

Guide blocks 141 may be partially enclosed in side members 134 and configured to slide within side members 134. In one embodiment, side members 134 may be C-channels and guide blocks 141 may be substantially rectangular in shape. In another embodiment, side members 134 may contain grooves and guide blocks 141 may comprise guide wheels that roll within the groove of side members 134. As previously described, when actuator 150 is activated, lift bar 152 may move and cause lift sled 140 to move. When lift sled 140 is raised or lowered, guide blocks 141 may be correspondingly raised or lowered within side members 134. As a result, guide blocks 141 may provide stability as the lift sled 140 is raised or lowered.

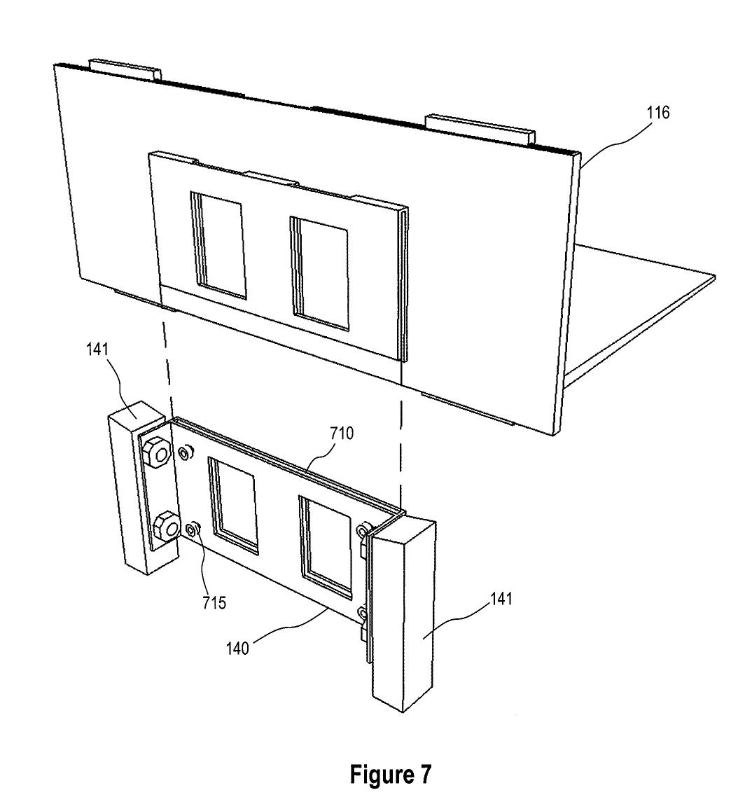

FIG. 7 shows lift sled 140 and lifting toe 116 of hand truck 100 according to an embodiment of the invention. Lift sled 140 may be configured to receive various lifting toes. In one embodiment, lifting toe 116 may be coupled to lift sled 140 (FIG. 5) by mating the back of lifting toe 116 with a recess 710 in lift sled 140. Threaded fastening devices 715 may then be used to tighten the mated connection between the lifting toe 116 and lift sled 140. In another embodiment, lifting toe 116 may be directly connected to lift sled 140. For example, the back of lifting toe 116 may be bolted, snapped, adhered, or screwed to lift sled 140.

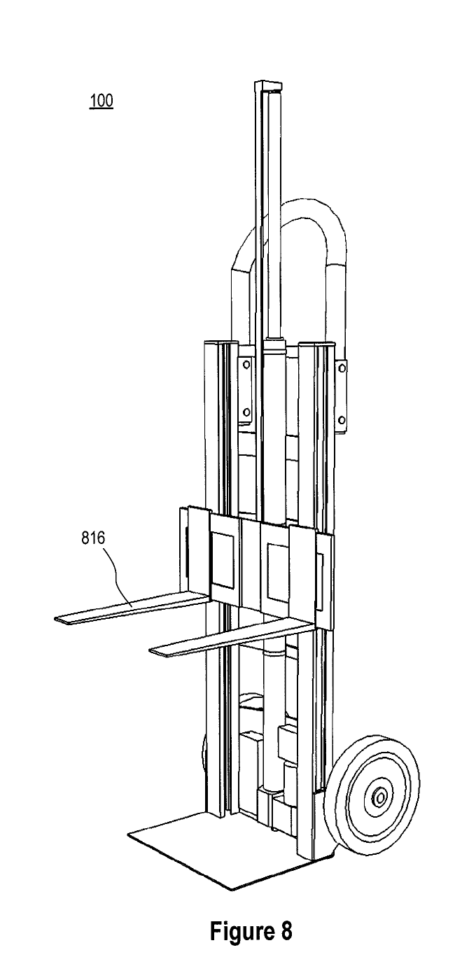

As described above, various lifting toes may be used with hand truck 100. Lifting forks 816 illustrated in FIG. 8, for example, may be attached to lift sled 140 (FIG. 6). In at least one embodiment, lifting forks 816 may be laterally moved relative to one another to adjust distance between the forks. In another embodiment, lifting forks 816 may be fixed relative to one another.

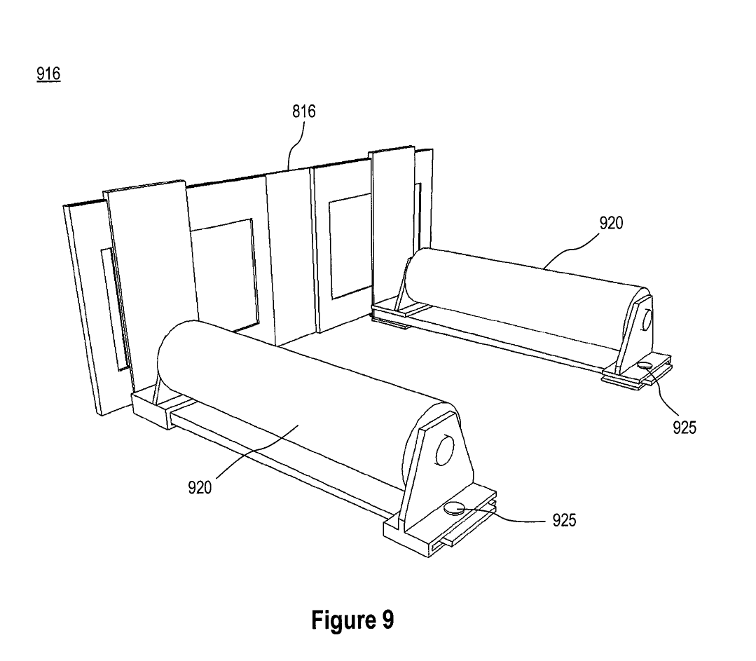

Additionally, lifting toes attached to lift sled 140 may be modified by adding an attachment. For example, as illustrated in FIG. 9, roller wheels 920 may be attached to forks 816 with pins 925 to create a lifting toe 916. In alternative embodiments, roller wheels 920 may snap or strap onto forks 816. It will be appreciated that other approaches, such as screwing or bolting, may also be used to add an attachment to a lifting toe and the present invention is not limited to these particular embodiments.

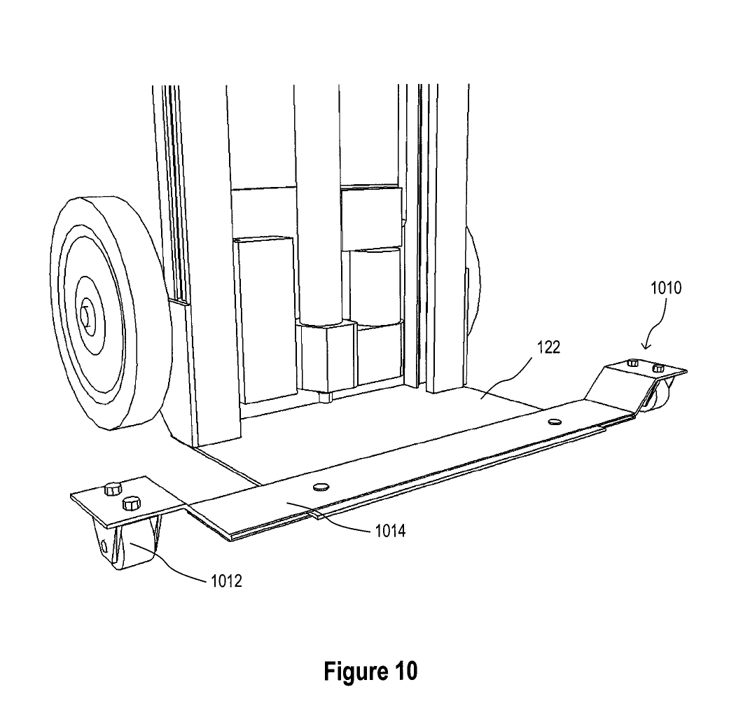

Base plate 122 may also be modified by adding an attachment. For example, as shown in FIG. 10, a castor apparatus 1010 may be added to base plate 122. The castor apparatus 1010 may include castor wheels 1012 and an attachment body 1014, and may be coupled to base plate 122 by pins 1025. The castor apparatus 1010 may be attached to the base plate 122 by other attachment techniques as well. In at least one embodiment, pins 1025 may be removed to allow castor apparatus 1010 to be detached from base plate 122. When hand truck 100 has been modified with castor apparatus 1010, hand truck 100 may be moved along a surface in an upright position.

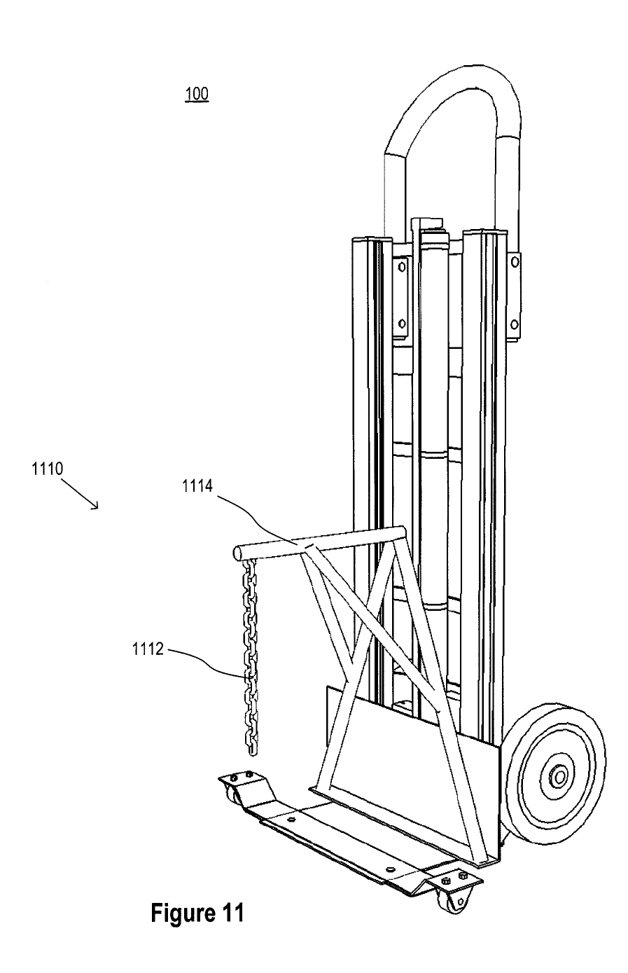

At least one embodiment of hand truck 100 may include lifting toe 1110 as illustrated in FIG. 11. The lifting toe 1110 illustrated in FIG. 11 is attached to the lift sled 140. Other attachment techniques can be used as well, for example, attaching the lifting toe 1110 to lifting toe 116. Lifting toe 1110 may include a suspension apparatus 1112 and support arm 1114. Suspension apparatus 1112 may be a chain, rope, cable, belt, or other suitable suspension line. In one embodiment, hand truck 100 may utilize lifting toe 1110 and castor apparatus 1010 (FIG. 10) simultaneously. As a result, hand truck 100 may be used to hoist objects above a surface and move the objects while hand truck 100 is in an upright position.

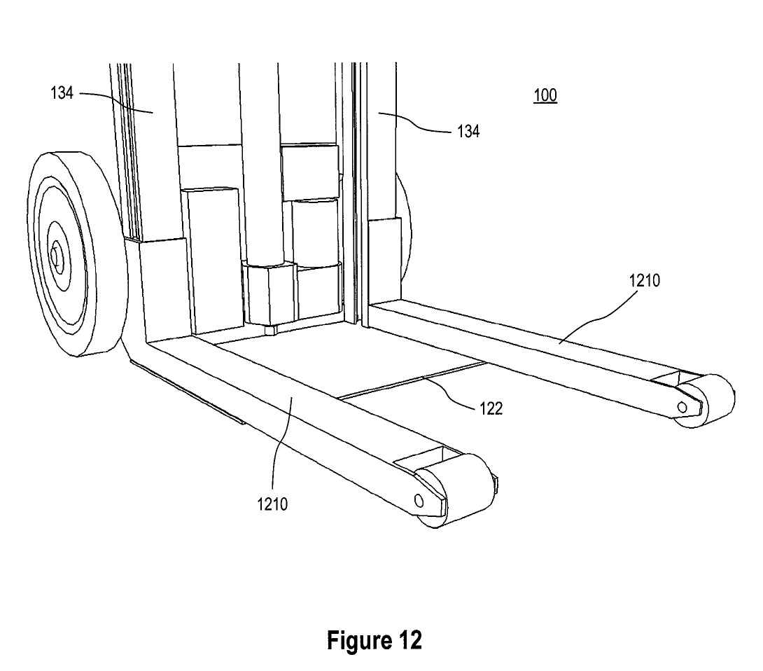

As illustrated in FIG. 12, base 110 of hand truck 100 may be permanently modified with an attachment. For example, permanent castor wheel attachments 1210 may be attached to ends of side members 134 and surface of base plate 122. Permanent castor wheel attachments 1210 may allow for additional support of hand truck 100 and allow hand truck 100 to be moved in an upright position.

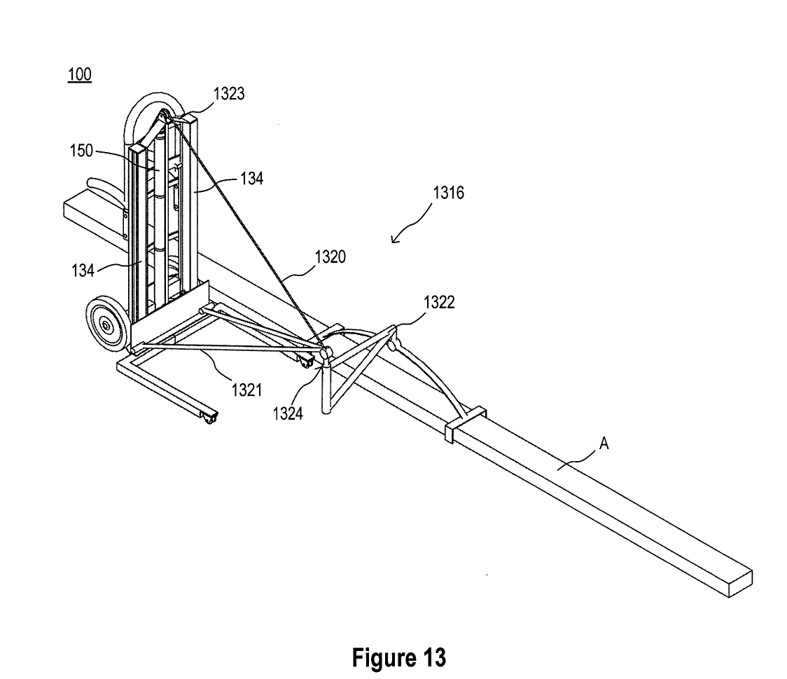

FIG. 13 illustrates hand truck 100 with a lifting toe 1316 according to an embodiment of the invention. Lifting toe 1316 may comprise a support bracket 1323, a support line 1320, base arms 1321, and a clamp arm 1322. Support line 1320 may be coupled to a support bracket 1323 as well as clamp arm 1322. Base arms 1321 may also be coupled to clamp arm 1322. Support bracket 1323 may further be coupled to an end of each side member 134.

In operation, clamp arm 1322 may be secured to an object A. Lifting toe 1316 may subsequently be raised by actuator 150 to suspend the object secured by clamp arm 1322 at a desired height. Clamp arm 1322 may also be rotated at pivot 1324 to change the orientation of the object relative to hand truck 100. The object may then be moved with hand truck 100 in an upright position.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A hand truck, comprising:
a lifting toe;
a lift apparatus coupled to the lifting toe and configured to displace the lifting toe;
a microprocessor configured to output a plurality of control signals;
an actuator coupled to the lift apparatus, the actuator configured to displace the lift apparatus responsive, at least in part, to the microprocessor outputting at least one of a plurality of control signals.

2. The hand truck of claim 1, further comprising:
a sensor coupled to the microprocessor and configured to output a weight signal based at least in part on the weight of a load on the lifting toe, the microprocessor further configured to output the plurality of control signals based, at least in part, on the weight signal.

3. The hand truck of claim 1, wherein the lift sled is displaced a first distance and the first distance is based, at least in part, on a time interval.

4. The hand truck of claim 1, wherein the lifting toe is configured to mate with the lift sled.

5. The hand truck of claim 1, wherein the lift apparatus further comprises:
a lift sled coupled to the lifting toe; and
a lift bar coupled to the lifting toe and the actuator.

6. The hand truck of claim 1, wherein the lifting toe is a forked lifting toe.

7. The hand truck of claim 1, further comprising:
a user interface coupled to the microcontroller and configured to output commands.

8. The hand truck of claim 1, further comprising:
a base plate; and
a castor apparatus attached to the base plate and configured to allow the hand truck to be rolled in an upright position.

9. A hand truck, comprising:
a lift sled;
a sensor coupled to the lift sled and configured to output a load signal;
an actuator coupled to the lift sled; and
a microprocessor coupled to the sensor and the actuator, and configured to receive the load signal, comprising:
control logic configured to control the actuator based, at least in part, on the load signal responsive to the microprocessor operating in a first mode, the control logic further configured to be programmable responsive to the microprocessor operating in a second mode.

10. The hand truck of claim 9, wherein the microprocessor is further configured to receive and execute manual commands responsive to the microprocessor executing in a third mode.

11. The hand truck of claim 9, further comprising:
a receiver coupled to the microprocessor and configured to receive commands over a wireless connection.

12. The hand truck of claim 10, further comprising:
a control interface coupled to the microprocessor and configured to program the control logic responsive to the microprocessor operating in a second mode, the control interface further configured to output commands responsive to the microprocessor operating in a third mode.

13. The hand truck of claim 9, wherein the load signal corresponds to a downward force applied to the lift sled.

14. The hand truck of claim 9, further comprising:
a lifting toe coupled to the lifting sled, the lifting toe configured to mate with the lifting sled.

15. A method of displacing an object with a hand truck, comprising:
changing the load on a lifting toe from a first weight to a second weight;
activating an actuator responsive at least in part on changing the load;
moving a lift sled in a first direction responsive to activating the actuator; and
moving the lifting toe in the first direction using the lift sled.

16. The method of claim 15, further comprising:
after said changing the load, sensing a change in load on the lifting toe and activating an actuator responsive to the sensing.

17. The method of claim 16, wherein said moving a lift sled comprises:
moving the lift sled a predetermined distance in the first direction based, at least in part, on said sensing.

18. The method of claim 15, further comprising:
changing the load on the lifting toe from the second weight to a third weight;
activating the actuator;
moving the lift sled in a second direction; and
moving the lifting toe in the second direction.

19. The method of claim 15, wherein said moving a lift sled comprises:
moving a lift bar in the first direction;
moving the lift sled in the first direction.

20. The method of claim 15, wherein said changing the load comprises:
suspending an object with a lifting toe.
